(19) United States
(12) Patent Application Publication
(10) Pub. No.: US 2013/0145974 A1
(43) Pub. Date: Jun. 13, 2013

(54) COMPOSITION AND METHOD FOR REDUCING SOx and NOx EMISSIONS FROM COMBUSTION OF FUEL

(71) Applicant: Robert E. Brandt, Tucson, AZ (US)

(72) Inventor: Robert E. Brandt, Tucson, AZ (US)

(21) Appl. No.: 13/701,504

(22) PCT Filed: Jun. 1, 2011
(86) PCT No.: PCT/US11/38756

§ 371 Date: Jan. 6, 2013

Related U.S. Application Data
(60) Provisional application No. 61/350,368, filed on Jun. 1, 2010.

(51) Int. Cl. C10L 10/00; B08B 5/00; F23J 15/02

(52) U.S. Cl. CPC C10L 10/00; F23J 15/02; B08B 5/00
USPC 110/345; 44/398; 44/620; 134/19

(57) ABSTRACT

A fuel mixture characterized by reduced SOₓ and NOₓ emissions from combustion of the fuel, comprising: fuel; and an ester additive derived from reaction of i) a C₆-C₁₆ aliphatic straight chain or branched chain monocarboxylic acid, wherein aliphatic is defined as of or relating to a major group of organic compounds, structured in open or branched chains, including alkanes, e.g. paraffins, alkenes, e.g. olefins, and alkynes e.g., acetylenes, and either, ii) an aliphatic polyhydric alcohol having three or more primary alcohol groups, or iii) a C₁-C₁₆ aliphatic straight or branched chain monohydric alcohol. A method of reducing SOₓ and NOₓ emissions from combustion of the fuel, comprising: mixing fuel and an ester additive; and combusting the mixture, wherein SOₓ and NOₓ emissions are at least about 20% to about 40% w/w of the SOₓ and NOₓ emissions from combustion of the fuel without admixture with the ester additive.

### FIELD OF THE INVENTION

The present invention relates generally to mixtures of esters and hydrocarbon fuel, and methods of using thereof. More specifically, the present invention relates to mixtures of esters and hydrocarbon fuel having reduced emissions of nitrogen and sulfur oxides and methods of reducing nitrogen and sulfur oxides from combustion of the mixtures.

### BACKGROUND

Within the past few years there has been an increasing concern with the immediate and long-term effects of atmospheric pollution produced during the burning of hydrocarbon fuels. During this time, substantial amounts of money and effort have been spent to combat this problem. Additionally, the governmental agencies, on the federal, state, and local levels have issued environmental regulations which severely limit the amount of pollutants which can be released into the atmosphere, consequently forcing users of these fuels to make the choice of burning the more expensive, “clean-burning”, fuels or, as the supply of such fuels is shrinking, to seek methods to reduce the emissions released by the combustion of the higher-polluting fuels.

A class of pollutants that has, recently, become a major concern is that of nitrogen (NOₓ) and/or sulfur oxides SOₓ from hydrocarbon fuels. Examples of NOₓ are gaseous N₂O₂, NO, and NO₂, and examples of SOₓ are gaseous sulfur compounds such as H₂S, COS, SO₂, SO₃ and the like. When released into the atmosphere, it has been postulated, these compounds can react with atmospheric moisture and oxygen to form nitric and sulfuric acid, which results in “acid rain”, severely corrosive precipitation that is detrimental to plant and animal life. For this reason, particularly stringent restrictions have been placed upon the amount of nitrogen and gaseous sulfur compounds, notably the oxidized forms of nitrogen and sulfur produced during nitrogen and sulfur burning, NOₓ and SOₓ, which can be released into the atmosphere during combustion of fuels. Such restrictions have made it nearly impossible to utilize high nitrogen and/or sulfur content fuels in standard applications. Since many of the viscous hydrocarbon fuels discussed, and much of the world's coal reserves, have high nitrogen and/or sulfur content, use of a significant portion of the world's petroleum and coal reserves presents difficult environmental and economic problems. As the world's hydrocarbon reserves are shrinking, the use of these other fuels becomes necessary.

For this reason, scientists have attempted to lower the gaseous nitrogen and sulfur emissions of high nitrogen and sulfur content fuels. Three main approaches have been used. In the first, the combustion gases are channelled through an NOₓ and/or SOₓ absorbent prior to release into the atmosphere, resulting in reduced NOₓ and/or SOₓ levels in the effluent gas. This method, also known as “scrubbing” is the most common method in use today; however, it suffers from the major drawback of requiring significant capital outlay for the design and construction of the system. Nonetheless, this is the principal NOₓ and/or SOₓ control method in use today.

An alternative approach involves the removal of the sulfur from the fuel prior to the combustion. This may be accomplished by extracting the nitrogen and/or sulfur components into solvents having a stronger affinity for the nitrogen and/or sulfur compounds than the fuel. Such solvents are, however, expensive and often will extract significant amounts of combustible fuel components along with the nitrogen and/or sulfur. For these reasons, this method has proven to be impractical.

More useful, in the case of petroleum hydrocarbons, is hydrogen addition to convert the nitrogen and/or sulfur in the sulfur compounds to elemental nitrogen (N₂) and/or hydrogen sulfide (H₂S), which can be separated from the petroleum fraction. However, this process also requires significant capital outlay.

There exists, therefore, a real need for compositions and methods for reducing nitrogen and/or sulfur oxide emissions from combustion of fuel, yet which will not exhibit deleterious effects such as fouling.

### SUMMARY OF THE INVENTION

A first aspect of the present invention provides a method for reducing SOₓ and NOₓ emissions from combustion of fuel, comprising: mixing fuel and an ester additive; combusting the mixture, wherein SOₓ and NOₓ emissions are at least about 20% to about 40% w/w of the SOₓ and NOₓ emissions from combustion of the fuel without admixture with the ester additive.

A second aspect of the present invention provides A fuel mixture characterized by for reduced SOₓ and NOₓ emissions from combustion of the fuel, comprising: fuel; and an ester additive derived from reaction of
i) a C₆-C₁₆ aliphatic straight chain or branched chain monocarboxylic acid, wherein aliphatic is defined as of or relating to a major group of organic compounds, structured in open or branched chains, including alkanes, e.g. paraffins, alkenes, e.g. olefins, and alkynes e.g., acetylenes, and either,
ii) an aliphatic polyhydric alcohol having three or more primary alcohol groups, or
iii) a C₁-C₁₆ aliphatic straight or branched chain monohydric alcohol, wherein the amount of ester additive is between about 2×10⁻⁷ oz. and about 7×10⁻⁷ oz. per BTU from the fuel.

### BRIEF DESCRIPTION OF THE FIGURES

FIG. 1 depicts a longitudinal cross sectional view of a rotary kiln, according to embodiments of the present invention; and

FIG. 2 depicts a flow diagram of a method for reducing SOₓ and NOₓ emissions from combustion of fuel, according to embodiments of the present invention.

### DETAILED DESCRIPTION OF THE EMBODIMENTS OF THE INVENTION

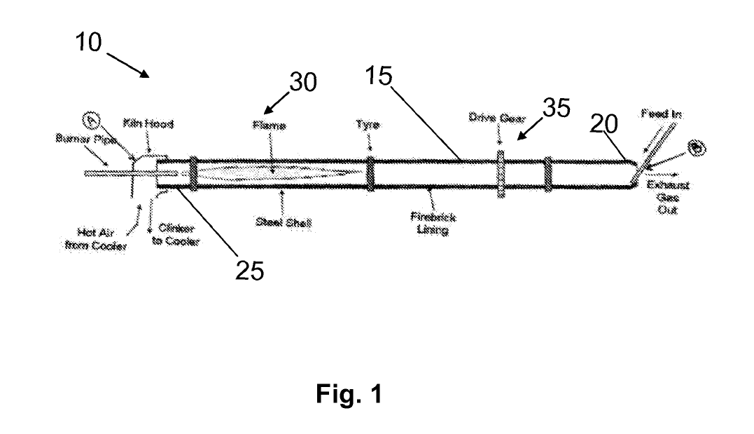

FIG. 1 depicts a rotary kiln 10, comprising: a tube 15 made from steel plate, and lined with firebrick. The tube slopes slightly (1-4°) and slowly rotates on its axis at between 30 and 250 revolutions per hour. Raw mix is fed into an upper portion 35 at the upper end 20, and the rotation of the kiln 10 causes it gradually to move downhill to the other end 25 of the kiln. At the other end 25 fuel, in the form of gas, oil, or pulverized solid fuel, is blown in through the burner pipe, producing a large concentric flame, which defines a remaining portion 30 of the kiln tube 15. As material moves under the flame, it reaches its peak temperature, before dropping out of the kiln tube into the cooler. Air is drawn first through the cooler and then through the kiln for combustion of the fuel. In the cooler the air is heated by the cooling clinker, so that it may be 400° C. to 800° C. before it enters the kiln 10, thus causing intense and rapid combustion of the fuel.

The fuel mixture characterized by reduced SOₓ and NOₓ emissions from combustion of the fuel, comprises: fuel; and an ester additive derived from reaction of

i) a C₆-C₁₆ aliphatic straight chain or branched chain monocarboxylic acid, wherein aliphatic is defined as of or relating to a major group of organic compounds, structured in open or branched chains, including alkanes, e.g. paraffins, alkenes, e.g. olefins, and alkynes e.g., acetylenes, and either,

ii) an aliphatic polyhydric alcohol having three or more primary alcohol groups, or

iii) a C₁-C₁₆ aliphatic straight or branched chain monohydric alcohol, wherein the amount of ester additive is between about 2×10⁻⁷ oz. and about 7×10⁻⁷ oz. per BTU from the fuel.

The fuel may be “fuel grade” coal or hydrocarbon fuel. The kiln 10 may be a furnace for calcining cement. The ester additive may be selected from the group consisting of dipentaerthritol hexaheptanoate and 1,1,1-trimethylol propane trinonanoate.

In one embodiment, the ester additive of the fuel mixture advantageously includes esters represented by the following structures:

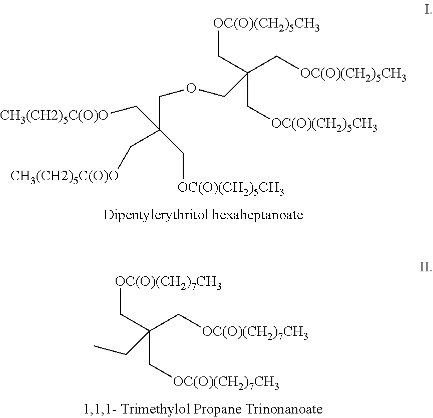

In one embodiment, when the fuel in the fuel mixture is coal, an amount of the ester additive is advantageously at least 7 oz. per ton of coal.

The fuel mixture of claim 11, wherein the fuel is selected from the Hydrocarbon Fuel group including bunker fuel, kerosene, diesel fuel, and gasoline, and the amount of ester additive is at least 2 oz. per 20.0 gal. of fuel.

The fuel mixture of claim 11, wherein the aliphatic monocarboxylic acid (i) is a C₆-C₁₂ aliphatic straight chain or branched chain monocarboxylic acid.

The fuel mixture of claim 11, wherein the aliphatic monocarboxylic acid (i) is selected from the group consisting of n-hexanoic acid, n-heptanoic acid, n-octanoic acid, n-nonanoic acid, n-decanoic acid, n-undecanoic acid, and n-dodecanoic acid.

In one embodiment, each ester in the ester additive is derivable by reacting together:

i) a C₆-C₁₆ aliphatic straight chain or branched chain monocarboxylic acid, wherein aliphatic is defined as of or relating to a major group of organic compounds, structured in open or branched chains, including alkanes, e.g. paraffins, alkenes, e.g. olefins, and alkynes e.g., acetylenes, and either;

ii) an aliphatic polyhydric alcohol having three or more primary alcohol groups, or

iii) a C₁-C₁₆ aliphatic straight or branched chain monohydric alcohol.

In one embodiment, the ester additive includes esters represented by the following structures:

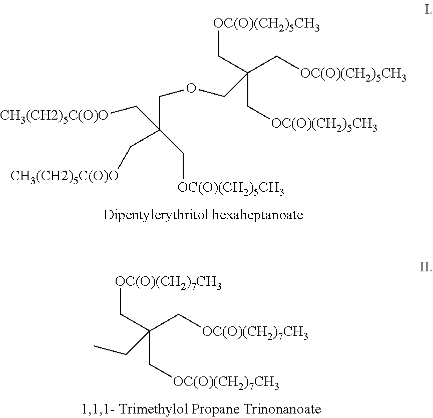

In one embodiment, the ester additive includes esters represented by the following structures:

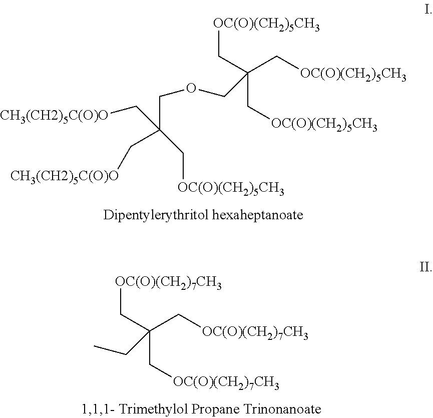

In one embodiment, the fuel is coal, and an amount of the ester additive is at least 7 oz. per ton of coal.

In one embodiment, the fuel is advantageously selected from the Hydrocarbon Fuel group including bunker fuel, kerosene, diesel fuel, and gasoline, and the amount of ester additive is at least 2 oz. per 20.0 gal. of fuel.

In one embodiment, the amount of ester additive is advantageously between about 2×10⁻⁷ oz. and about 7×10⁻⁷ oz. per BTU from the fuel.

In one embodiment, the aliphatic monocarboxylic acid (i) is a C₆-C₁₂ aliphatic straight chain or branched chain monocarboxylic acid.

In one embodiment, the aliphatic monocarboxylic acid (i) is selected from the group consisting of n-hexanoic acid, n-heptanoic acid, n-octanoic acid, n-nonanoic acid, n-decanoic acid, n-undecanoic acid, and n-dodecanoic acid.

In one embodiment, the aliphatic polyhydric alcohol (ii) is selected from the group consisting of 1,1,1-trimethylolpropane, pentaerythritol, dipentaerythritol, tripentaerythritol, and combinations thereof.

In one embodiment, esters derivable from the aliphatic polyhydric alcohol (ii) are at least 0%-25% w/w of the ester additive.

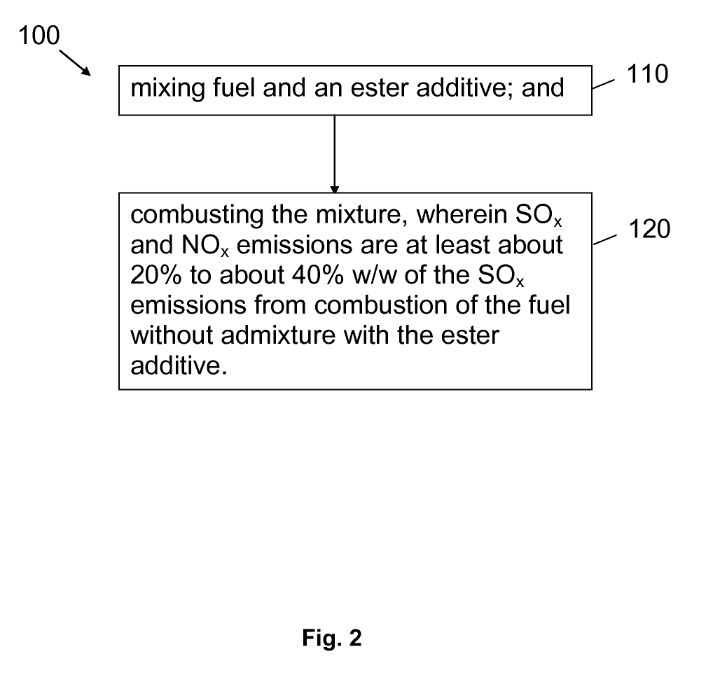

FIG. 2 is a flow diagram depicting a method 100 for treating a kiln 10 to reduce SOₓ and NOₓ from combustion of sulfur and nitrogen containing waste.

The method 100 comprises a step 110: mixing fuel and an ester additive in the fuel line of the kiln 10.

The method 100 comprises a step 120: combusting the mixture, wherein SOₓ emissions are at least about 20% to about 40% w/w of the SOₓ and NOₓ emissions from combustion of the fuel without admixture with the ester additive.

In one embodiment of the method 100, the ester additive is derived from reaction of:

i) a C₆-C₁₆ aliphatic straight chain or branched chain monocarboxylic acid, wherein aliphatic is defined as of or relating to a major group of organic compounds, structured in open or branched chains, including alkanes, e.g. paraffins, alkenes, e.g. olefins, and alkynes e.g., acetylenes, and either,

i) an aliphatic polyhydric alcohol having three or more primary alcohol groups, or

ii) a C₁-C₁₆ aliphatic straight or branched chain monohydric alcohol, wherein the amount of ester additive is between about 2×10⁻⁷ oz. and about 7×10⁻⁷ oz. per BTU from the fuel.

In one embodiment of the method 100, the aliphatic polyhydric alcohol (ii) is selected from the group consisting of 1,1,1-trimethylolpropane, pentaerythritol, dipentaerythritol, tripentaerythritol, and combinations thereof.

In one embodiment of the method 100, esters derivable from the aliphatic polyhydric alcohol (ii) are at least 0%-25% w/w of the ester additive.

### Example 1

I was able to arrange a test burn in a pilot kiln to assess the viability. The pilot kiln had been test burning several hazardous waste options for creation of cement products. The refractory in the kiln had been subjected to this burning process for 14 days prior to my test.

The kiln 10, shown in FIG. 1, was brought up to 1200° C., burning 37 lbs/hr. of High Sulfur coal. The initial baseline for the SOₓ was 8.0-8.5 ppm measured at the exhaust stack, down-stream from the kiln hood, shown in FIG. 1. Six (6) cc of a mixture containing a blend of Methyl laurate (35.5 wt. %+/−5%), Methyl myristate (35.5 wt. %+/−5%), 1,1,1-trimethylolpropane trinonoate (9.3 wt. %+/−5%), Methyl palmitate (4.3 wt. %+/−5%) and Dipentaerythritol hexaheptanoate (15.2 wt. %+/−5%) was introduced into the flame (1800° C.) of the kiln 10 at point A in FIG. 1, while continuing to burn 37 lbs/hr. of High Sulfur coal. This application did not change the baseline of SOₓ significantly. A second injection of six (6) cc of the mixture containing a blend of Methyl laurate (35.5 wt. %+/−5%), Methyl myristate (35.5 wt. %+/−5%), 1,1,1-trimethylolpropane trinonoate (9.3 wt. %+/−5%), Methyl palmitate (4.3%) and Dipentaerythritol hexaheptanoate (15.2 wt. %+/−5%) into the flame (1800° C.) of the kiln 10 at point A in FIG. 1, while continuing to burn 37 lbs/hr. of High Sulfur coal, again did not change the baseline of SOₓ significantly.

### Example 2

The kiln 10, shown in FIG. 1, was brought up to 1200° C., burning 37 lbs/hr. of High Sulfur coal. The initial baseline for the SOₓ was 8.0-8.5 ppm measured at the exhaust stack, down-stream from the kiln hood, shown in FIG. 1. Six (6) cc of an ester mixture containing a blend of Methyl laurate (35.5 wt. %+/−5%), Methyl myristate (35.5 wt. %+/−5%), 1,1,1-trimethylolpropane trinonoate (9.3 wt. %+/−5%), Methyl palmitate (4.3 wt. %+/−5%) and Dipentaerythritol hexaheptanoate (15.2 wt. %+/−5%) was then introduced into the hot air stream at point B at the feed end 20 of the kiln 10 in FIG. 1 (1000° C. to 1200° C.). Hereinafter, the “ester mixture”, unless otherwise defined, is an ester mixture containing a blend of Methyl laurate (35.5 wt. %+/−5%), Methyl myristate (35.5 wt. %+/−5%), 1,1,1-trimethylolpropane trinonoate (9.3 wt. %+/−5%), Methyl palmitate (4.3 wt. %+/−5%) and Dipentaerythritol hexaheptanoate (15.2 wt. %+/−5%). The SOₓ concentration dropped to 4 ppm.

This 20-40% decrease in SOₓ was observed again when a second six (6) cc injection of the ester mixture containing a blend of Methyl laurate (35.5 wt. %+/−5%), Methyl myristate (35.5 wt. %+/−5%), 1,1,1-trimethylolpropane trinonoate (9.3 wt. %+/−5%), Methyl palmitate (4.3 wt. %+/−5%) and Dipentaerythritol hexaheptanoate (15.2 wt. %+/−5%) was repeated, after the baseline had returned to 8.0-8.5 ppm SOₓ.

In Example 2, the two injections of the ester mixture resulted in the reduction of SOₓ to 20% to 40% of the original 8.0-8.5 ppm baseline. The kiln 10 was allowed to return to the original 8.0-8.5 ppm SOₓ baseline between each injection of the ester mixture in Example 2. About ten minutes was required between each injection of the ester mixture in Example 2, in order for the SOₓ baseline to return to approximately 8.0-8.5 ppm SOₓ.

However, instead of returning to the 8.0 ppm SOₓ baseline after the second injection of the ester mixture in Example 2, a new SOₓ baseline at 14.0-14.5 ppm had become established. The SOₓ baseline of the kiln 10 remained at 14.0 ppm for several hours before testing was discontinued.

In theory, introducing the ester mixture into the flame area 30 had released the residual particles of SOₓ attached to the refractory of the kiln 10. Hereinafter, the refractory of the kiln 10, unless otherwise defined, is the firebrick lining of the kiln 10, depicted in FIG. 1, and also includes all of the ducts and passages where the hot air passes. According to this theory, introducing the ester mixture, as in Example 2, may clean the refractory and walls of ducts and passages where the hot air passes, shown by the increase of the SOₓ baseline from 8.0-8.5 ppm to 14.0-14.5 ppm, providing expectation for a lower SOₓ baseline than 8.0-8.5 ppm after additional injections of the ester mixture. Also overall NOₓ reduction in the exhaust gases may be possible through improved combustion and then the possible reduction of sulfur or nitrogen containing Hydrocarbon fuels necessary to optimize combustion.

The mono carboxylic acid esters of the ester mixture, e.g. Methyl laurate, MW=194 (derived from a C12 acid), Methyl myristate, MW=222 (derived from a C14 acid), and Methyl palmitate, MW=250 (derived from a C16 acid) have molecular weights ranging from 194 to 250. By contrast, the molecular weight of 1,1,1-trimethylolpropane trinonanoate is 602, and the molecular weight of Dipentaerythritol hexaheptanoate is 842.

In theory, esters differing in molecular weight (MW) by a factor of approximately 3 to 4 may offer several interesting characteristics, e.g. 1,1,1-trimethylolpropane trinonanoate, MW=602, and Dipentaerythritol hexaheptanoate, MW=842 differ from methyl laurate, MW 194 by factors of 3.1 and 4.3, respectively. The lower 194 to 250 MW esters improve the flame and increases burn efficiency while the higher 602 to 842 MW esters survive the whole burn, while lubricating and lowering the temperatures in the combustion area.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. (canceled)

2. The method of claim 17, wherein each ester in the ester additive is derivable by reacting together:
(i) a C₆-C₁₆ aliphatic straight chain or branched chain monocarboxylic acid,
wherein aliphatic is defined as of or relating to a major group of organic compounds, structured in open or branched chains, including alkanes, e.g. paraffins, alkenes, e.g. olefins, and alkynes, e.g. acetylenes; and either
(ii) an aliphatic polyhydric alcohol having three or more primary alcohol groups; or
(iii) a C₁-C₁₆ aliphatic straight or branched chain monohydric alcohol.

3. The method of claim 2, wherein the ester additive includes esters represented by the following structures:

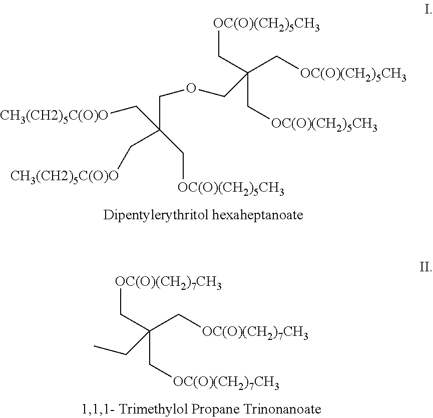

4. The method of claim 2, wherein the fuel is coal, and an amount of the ester additive is at least 7 oz. per ton of coal.

5. The method of claim 2, wherein the fuel is selected from the Hydrocarbon Fuel group including bunker fuel, kerosene, diesel fuel, and gasoline, and the amount of ester additive is at least 2 oz. per 20.0 gal. of fuel.

6. The method of claim 2, wherein the amount of ester additive is between about 2×10⁻⁷ oz. and about 7×10⁻⁷ oz. per BTU from the fuel.

7. The method of claim 2, wherein the aliphatic monocarboxylic acid (i) is a C₆-C₁₂ aliphatic straight chain or branched chain monocarboxylic acid.

8. The method of claim 7, wherein the aliphatic monocarboxylic acid (i) is selected from the group consisting of n-hexanoic acid, n-heptanoic acid, n-octanoic acid, n-nonanoic acid, n-decanoic acid, n-undecanoic acid, and n-dodecanoic acid.

9. The method of claim 2, wherein the aliphatic polyhydric alcohol (ii) is selected from the group consisting of 1,1,1-trimethylolpropane, pentaerythritol, dipentaerythritol, tripentaerythritol, and combinations thereof.

10. The method of claim 9, wherein esters derivable from the aliphatic polyhydric alcohol (ii) are at least 0%-25% w/w of the ester additive.

11. A fuel mixture characterized by for reduced SOₓ and NOₓ emissions from combustion of the fuel, comprising:
fuel; and
an ester additive derived from reaction of
i. a C₆-C₁₆ aliphatic straight chain or branched chain monocarboxylic acid, wherein aliphatic is defined as of or relating to a major group of organic compounds, structured in open or branched chains, including alkanes, e.g. paraffins, alkenes, e.g. olefins, and alkynes e.g., acetylenes, and either,
ii. an aliphatic polyhydric alcohol having three or more primary alcohol groups, or
iii. a C₁-C₁₆ aliphatic straight or branched chain monohydric alcohol,
wherein the amount of ester additive is between about 2×10⁻⁷ oz. and about 7×10⁻⁷ oz. per BTU from the fuel.

12. The fuel mixture of claim 11, wherein the ester additive includes esters represented by the following structures:

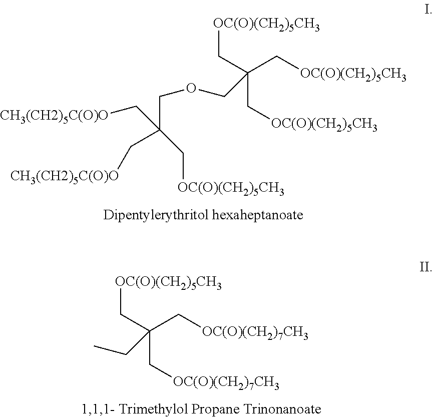

13. The fuel mixture of claim 11, wherein the fuel is coal, and an amount of the ester additive is at least 7 oz. per ton of coal.

14. The fuel mixture of claim 11, wherein the fuel is selected from the Hydrocarbon Fuel group including bunker fuel, kerosene, diesel fuel, and gasoline, and the amount of ester additive is at least 2 oz. per 20.0 gal. of fuel.

15. The fuel mixture of claim 11, wherein the aliphatic monocarboxylic acid (i) is a C₆-C₁₂ aliphatic straight chain or branched chain monocarboxylic acid.

16. The fuel mixture of claim 11, wherein the aliphatic monocarboxylic acid (i) is selected from the group consisting of n-hexanoic acid, n-heptanoic acid, n-octanoic acid, n-nonanoic acid, n-decanoic acid, n-undecanoic acid, and n-dodecanoic acid.

17. A method for reducing SOx and NOx emissions from combustion of fuel, comprising:
producing a hot air steam from combustion of a fuel in a kiln;
introducing an ester additive into the hot air stream of the kiln,
wherein SOₓ and NOₓ emissions after introducing the ester additive are at least about 20% to about 40% w/w of the SOₓ and NOₓ emissions from combustion of the fuel without introducing the ester additive.

18. A method of cleaning a refractory and ducts of a kiln, comprising:
1) producing a hot air steam from combustion of a fuel in a kiln;
2) introducing an ester additive into the hot air stream of the kiln;
3) repeating step 1 until there is essentially no change in SOₓ and NOₓ emissions from combustion of the fuel.
